(19) United States
(12) Patent Application Publication
(10) Pub. No.: US 2021/0407524 A1
(43) Pub. Date: Dec. 30, 2021

(54) METHOD FOR CONVERTING A FIRST SET OF SIGNALS REPRESENTATIVE OF A SOUND FIELD INTO A SECOND SET OF SIGNALS AND ASSOCIATED ELECTRONIC DEVICE

(71) Applicant: FONDATION B-COM, Cesson Sevigne (FR)

(72) Inventors: Nicolas EPAIN, Rennes (FR); Francois SALMON, Betton (FR)

(21) Appl. No.: 17/362,704

(22) Filed: Jun. 29, 2021

(30) Foreign Application Priority Data
Jun. 30, 2020 (FR) 2006878

(51) Int. Cl. G10L 19/008; H04S 7/00; H04S 3/02

(52) U.S. Cl. CPC G10L 19/008; H04S 7/30; H04S 2420/07; H04S 2420/11; H04S 3/02

(57) ABSTRACT

A conversion method comprises the following steps:
for each of the signals (b_{E}(t)) of a first set, determining values (α(f)) respectively associated with frequency bands;
for each frequency band, converting the values (α(f)) associated with the relevant frequency band into at least one value representative of a virtual sound source oriented along the spatial direction associated with a data item stored for the relevant temporal frequency band;
for each temporal frequency band, determining, on the basis of an above-mentioned representative value, a plurality of values (γ(f)) associated with the different signals (b_{S}(t)) of the second set, respectively;
constructing each signal (b_{S}(t)) of the second set on the basis of the values (γ(f)) associated with this signal of the second set.

### TECHNICAL FIELD OF THE INVENTION

The present invention relates to the technical field of processing signals representative a sound field.

In particular, it relates to a method for converting a first set of signals representative of a sound field into a second set of signals and an associated electronic device.

### STATE OF THE ART

It has already been proposed to convert a first set of signals representative of a sound field into a second set of signals, for example to allow the restitution of the sound field by applying the signals of the second set to a reproduction system (audio headset or loudspeakers).

The signals of the first set have sometimes, in this situation, a format that is not directly usable by the reproduction system. It is typically a scene-based format, such as HOA (“High-Order Ambisonics”) format.

A solution of this type is proposed in the article “COMPASS: Coding and Multidirectional Parametrization of Ambisonic Sound Scenes”, A. Politis, S. Tervo and V. Pulkki in Proceedings of the 2018 IEEE International Conference on Acoustics, Speech and Signal Processing (ICASSP), April 2018.

Like other solutions moreover mentioned in this article, this solution is based on the estimation of at least one dominant direction per frequency band by analysis of the signals of the first set.

This analysis has however a significant computational cost and therefore requires a non-negligible processing time.

### DISCLOSURE OF THE INVENTION

In this context, the present invention provides a method for converting a first set of signals representative or a sound field in a space into a second set of signals by means of an electronic device, characterized in that the electronic device stores, for each temporal frequency band of a plurality of temporal frequency bands of the sound field, at least one data item associated with a particular spatial direction, the set of these particular spatial directions associated with a data item for at least one temporal frequency band forming a mesh over the set of spatial directions, and in that the method comprises the following steps:

for each of the signals of the first set, determining values associated with said temporal frequency bands, respectively;

for each temporal frequency band, converting the values associated with the relevant temporal frequency band and determined for the different signals of the first set, into at least one value representative of a virtual sound source oriented along the spatial direction associated with the data item stored for the relevant temporal frequency band;

for each temporal frequency band, determining, on the basis of said at least one value representative of a virtual sound source and obtained at the conversion step for the relevant temporal frequency band, a plurality of values associated with the different signals of the second set, respectively;

constructing each signal of the second set on the basis of the values associated with this signal of the second set and obtained for the different temporal frequency bands, respectively.

The use of predefined directions, for which associated data items are stored in the electronic device, avoids the analysis processing tasks used in the prior solutions.

Those directions however form a mesh (or grid) covering all the possible directions and waves present in the sound field will hence be represented in the constructed signals (signals of the second set), regardless of their dominant direction.

The electronic device stores for example, for each temporal frequency band, data items associated with a number of particular spatial directions equal to the number of signals in the first set of signals, which allows obtaining an optimum processing. It may be provided that, at the conversion step related to a given temporal frequency band, the values associated with the given temporal frequency band and determined for the different signals of the first set are converted into a plurality of values representative of virtual sound sources oriented along the respective spatial directions associated with the data items stored for the given temporal frequency band. Therefore, for each temporal frequency band, the input signals are converted into a plane wave representation along the different directions associated with the relevant frequency band.

The particular directions associated with the data items stored for a given temporal frequency band are for example distributed (potentially on a regular basis) among the set of spatial directions.

The number of signals in the second set is for example strictly higher than the number of signals in the first set. The conversion allows in this case an artificial increase of the spatial resolution of the sound scene represented.

Moreover, it may be provided that two directions associated with two data items stored for two respective adjacent frequency bands are neighbours in the mesh (or grid). This avoids performing very different processing tasks for neighbour frequency bands, which could create unwanted artefacts.

The set of said particular directions may include at least 50 particular directions, for example between 50 and 5000 particular directions.

The values associated with said temporal frequency bands, respectively, can be determined by time-frequency transformation on the basis of the signals of the first set. Each signal of the second set can itself be constructed by frequency-time transformation on the basis of the values associated with this signal of the second set and obtained for the different temporal frequency bands, respectively.

As described hereinafter, for each temporal frequency band, the conversion step can be carried out in practice by matrix multiplication of a vector comprising the values associated with the relevant temporal frequency band and determined for the different signals of the first set. The matrix used for this matrix multiplication as regards a given temporal frequency band can comprise the data stored for this given temporal frequency band and associated with the different particular directions allocated to this given temporal frequency band.

Moreover, for each temporal frequency band, the step of determining a plurality of values associated with the different signals of the second set, respectively, can be carried out by matrix multiplication of a vector comprising said at least one value representative of a virtual sound source and obtained at the conversion step for the relevant temporal frequency band. It is therefore possible to pass from a plane wave representation (by means of the values representative of sound sources) to a representation corresponding to the signals of the second set (output signals).

The method can also comprise preliminary steps of defining a plurality of spatial directions by an optimization process, allocating spatial directions of the plurality to said temporal frequency bands, and storing, for each temporal frequency band, said at least one data item associated with the spatial direction allocated to the relevant frequency band.

The invention further proposes an electronic device for converting a first set of signals representative of a sound field in a space into a second set of signals, characterized in that the electronic device comprises:

a storage unit adapted to store, for each temporal frequency band of a plurality of temporal frequency bands of the sound field, at least one data item associated with a particular spatial direction, so that the set of these particular spatial directions associated with a data item for at least one temporal frequency band forms a mesh over the set of spatial directions;

a transformation module adapted to determine, for each of the signals of the first set, values associated with said temporal frequency bands, respectively;

a decoding module adapted to convert, for each temporal frequency band, the values associated with the relevant temporal frequency band and determined for the different signals of the first set, into at least one value representative of a virtual sound source oriented along the spatial direction associated with the data item stored for the relevant temporal frequency band;

an encoding module adapted to determine, for each temporal frequency band,

a plurality of values associated with the different signals of the second set, respectively, on the basis of said at least one value representative of a virtual sound source and obtained by the decoding module for the relevant temporal frequency band;

a construction module adapted to construct each signal of the second set on the basis of the values associated with this signal of the second set and obtained for the different temporal frequency bands, respectively.

Of course, the different features, alternatives and embodiments of the invention may be associated with each other according to various combinations, insofar as they are not mutually incompatible or exclusive.

### DETAILED DESCRIPTION OF THE INVENTION

Moreover, various other features of the invention will be apparent from the appended description made with reference to the drawings that illustrate non-limitative embodiments of the invention, and wherein:

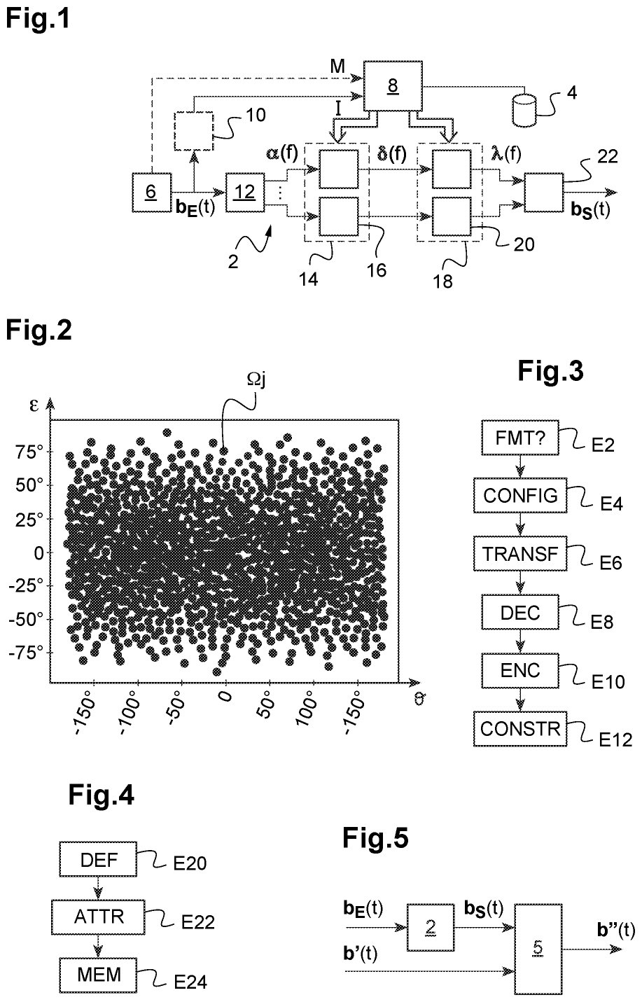

FIG. 1 is a functional representation of an electronic conversion device according to the invention;

FIG. 2 shows the set of spatial directions for which a data item is stored within the electronic device;

FIG. 3 is a flow diagram showing steps of a conversion method according to the invention;

FIG. 4 is a flow diagram showing steps of a method for defining and allocating particular spatial directions to different temporal frequency bands; and

FIG. 5 is a schematic representation of a possible application of the invention.

FIG. 1 shows an electronic device 2 for converting a first set of signals (or input signals) representative of a sound field in a space into a second set of signals (or output signals). The space concerned is the space of propagation of the sound waves; this space is herein three-dimensional. However, as an alternative, this space could be two-dimensional (for example, in the case of a two-dimensional representation of a three-dimensional system).

FIG. 1 represents the electronic device 2 as functional blocks (each forming a module or a unit as described hereinafter). In practice, each of these functional blocks can be made by the cooperation of software elements, such as computer program instructions executable by a processor of the electronic device, and hardware elements, for example this same processor and a memory of the electronic device 2.

This memory can moreover store the above-mentioned computer program instructions.

The input signals (or signals of the first set) are for example ambisonic signals of order L. The first set comprises in this case (L+1)² signals. The case of ambisonic input signals of order 1 (i.e. L=1) is described herein by way of illustration; with the first set then comprising 4 signals.

The processing made by the electronic device 2 on a given time interval is then described; this processing may be repeated for subsequent time intervals. In the following, b_{E}(t) will be used to denote the vector formed by the values taken by the different signals of the first set, respectively, at different times t of the considered time interval. (In the case of ambisonic input signals of order L, each vector b_{E}(t) is hence of dimension (L+1)², herein of dimension 4.) The number of successive times t at which the signals b_{E}(t) are considered is for example between 100 and 1000 for each time interval. The values taken by the different signals (and hence the different elements of the vectors b_{E}(t)) are for example complex values; as an alternative, these values could be real values.

Moreover, in the following, a plurality of temporal frequency bands of the sound field is considered. (The term “temporal frequency” is used in the present description to make it clear that these are not spatial frequencies, a notion that is also used in the present technical field.) In the example described herein, these temporal frequency bands are disjointed (or separated) two by two and cover (when gathered) the spectrum of the audible frequencies. The plurality of temporal frequency bands comprises for example between 100 and 1000 temporal frequency bands, here 256 temporal frequency bands. Each temporal frequency band has for example a width between 10 Hz and 500 Hz.

The electronic device 2 comprises a storage unit 4 adapted to store, for each temporal frequency band of this plurality of temporal frequency bands, at least one data item associated with a particular spatial direction n; (i.e. a particular direction Ωⱼ of the space mentioned above).

In the example described herein, the storage unit 4 stores, for each temporal frequency band, data items associated with a number of particular spatial directions Ωⱼ equal to the number of signals in the first set of signals (input signals), i.e. (L+1)² in the case of ambisonic input signals of order L. The directions so associated with a given temporal frequency band are denoted hereinafter Ω₁(f), Ω₂(f), . . . , Ω_{(L+1)}²(f).

The data item associated with a particular spatial direction n; can be a data item defining this particular spatial direction, for example by means of an azimuth angle and/or an elevation angle.

The data item associated with a particular spatial direction Ωⱼ can also be a data item making it possible to perform a calculation related to this particular direction

In the example described herein, to a particular direction Ωⱼ are for example associated several coefficients D_{k,i}(f) (forming a line of a matrix D(f)) making it possible to obtain the contribution of the different input signals, respectively, to a plane wave in the particular direction Ωₖ(f), as explained hereinafter.

FIG. 2 shows the set of particular spatial directions n; associated with a data item stored in the storage unit 4 in the example described herein.

Each particular direction Ωⱼ is defined herein by an azimuth angle θ (x-axis in FIG. 2) and an elevation angle ε (y-axis in FIG. 2).

The set of particular spatial directions Ωⱼ associated with a data item stored for at least one temporal frequency band forms a mesh (or grid) over the set of spatial directions (i.e. a mesh or grid covering the set of possible directions in the space mentioned above). The set of particular directions Ωⱼ comprises for example more than 50 particular directions.

As can be seen in FIG. 2, this mesh is not a regular mesh in the example described. As an alternative, it could however be a regular mesh (for example, with a constant azimuth pitch and a constant elevation pitch).

According to a possible implementation, for any azimuth value range having a width of 60° and any elevation value range having a width of 30°, the set of particular directions Ωⱼ comprises at least 5 particular directions n; defined by an azimuth θ included in this azimuth value range and an elevation ε included in this elevation value range.

According to another possible implementation (potentially compatible with the previous one), for any elevation value range having a width of 30° and any particular direction Ωⱼ of the set defined by an elevation ε included in this elevation value range and by a given azimuth θ, the set of particular directions comprises at least one particular direction Ωⱼ, defined by an elevation ε′ included in this elevation value range and by an azimuth θ′ that is different from the given azimuth θ by less than 30° (i.e. |θ′-θ|<30°, where |x| is the absolute value of x).

According to another possible implementation (potentially compatible with the previous ones), for any azimuth value range having a width of 60° and any particular direction Ωⱼ, of the set defined by an azimuth θ included in this azimuth value range and by a given elevation ε′, the set of particular directions comprises at least another particular direction ε′ defined by an azimuth θ′ included in this azimuth value range and by an elevation ε′ that is different from the given elevation ε by less than 30° (i.e. |ε′-ε|<30°).

A method for defining and allocating these particular spatial directions n; to the different temporal frequency bands will be described hereinafter with reference to FIG. 4.

The electronic device 2 comprises a reception module 6 adapted to receive data representative of the input signals (signals of the first set), here the vectors b_{E}(t) respectively associated with the successive times of the considered time interval. This reception module 6 can be a communication module adapted to receive the data representative of the input signals coming from another electronic device. As an alternative, the reception module 6 can be a module for reading the data representative of the input signals from a memory (such as the already-mentioned memory of the electronic device 2).

The electronic device 2 comprises a configuration module 8 adapted to configure the other modules, as a function in particular of the input signals b_{E}(t) (in particular, as a function of the format of the input signal b_{E}(t)). so For that purpose, the electronic device 2 can comprise a detection module 10 adapted to analyse the input signals b_{E}(t) and to provide the configuration module with information I indicative of the format of the input signals b_{E}(t). This information I is for example the number of signals which the input signals b_{E}(t) are made of.

As an alternative, the data representative of the input signals b_{E}(t) (received by the reception module 6) can comprise metadata M indicative of the format of the input signals b_{E}(t). It can be provided in this case that the reception module 6 transmits these metadata M to the configuration module 8, as shown in dotted-line in FIG. 1.

The operation of the configuration module 8 is described in detail hereinafter with reference to FIG. 3.

The electronic device 2 moreover comprises a transformation module 12 adapted to determine, for each of the input signals (signals of the first set), values associated with the different temporal frequency bands, respectively.

Using βᵢ(t) to denote the values taken over time (on the considered interval) by each input signal (so that b_{E}(t)=[β₁(t), β₂(t), . . . , β_{(L+1)}_{²}(t)]T), the transformation module 12 thus determines, on the basis of the values βᵢ(t) relating to a given input signal (denoted by the index i), values αᵢ(f) associated with the different frequency bands, respectively, and representative of this same input signal in the frequency domain.

For a given signal of the first set, the values αᵢ(f) associated with the different time frequency bands, respectively, are for example determined by time-frequency transformation (such as a short-term Fourier transformation) on the basis of the values

βᵢ(t) taken over time (on the considered time interval) by this signal of the first set.

For each frequency band, α(f) is used in the following to denote the vector formed by the values αᵢ(f) associated with the different input signals, respectively, for the relevant frequency band: α(f)=[α₁(f), α₂(f), α_{(L+1)}_{²}(f)]T.

The electronic device 2 comprises a decoding module 14 adapted to convert, for each temporal frequency band, the values α₁(f), α₂(f), α_{(L+1)}_{²}(f) associated with the relevant temporal frequency band and determined for the different signals of the first set, respectively, into values δ₁(f), δ₂(f), . . . , δ_{(L+1)}_{²}(f) each representative of a virtual sound source oriented along one of the spatial directions Ω₁(f), Ω₂(f), . . . , Ω_{(L+1)}_{²}(f) associated with the data items stored for the relevant temporal frequency band.

δ(f) is used in the following to denote the vector formed (for a temporal frequency band) by these values δ₁(f), δ₂(f), . . . , δ_{(L+1)}_{²}(f) representative of virtual sound sources oriented along the spatial directions Ω₁(f), Ω₂(f), . . . , Ω_{(L+1)}_{²}(f):

δ(f)=[δ₁(f), δ₂(f), . . . , δ_{(L+1)}_{²}(f)]^{T}.

The decoding module 14 performs for example, for each temporal frequency band, the above-mentioned conversion by matrix multiplication of the vector a(f), which comprises, as already indicated, the values α₁(f), α₂(f), . . . , α_{(L+1)}_{²}(f) associated with the relevant temporal frequency band and determined for the different signals of the first set, respectively.

For that purpose, the decoding module 14 uses for example a plurality of matrices D(f) associated with the different temporal frequency bands, respectively, and, for each temporal frequency band, multiplies the above-mentioned vector a(f) by the relevant matrix D(f) in order to obtain the values δ₁(f), δ₂(f), δ_{(L+1)}_{²}(f) representative of the respective virtual sound sources oriented along the spatial directions associated with the relevant temporal frequency band:

δ(f)=D(f)α(f).

The matrices D(f) are such that the values α₁(f), α₂(f), α_{(L+1)}_{²}(f), on the one hand, and the values δ₁(f), δ₂(f), . . . , δ(L+1)²(f), on the other hand, represent the same sound field, but in two different representations, here an ambisonic representation for the values al (f), α₂(f), α_{(L+1)}²(f) and a representation in plane waves oriented along the particular spatial directions associated with the relevant frequency band for the values δ₁(f), δ₂(f), . . . , δ_{(L+1)}_{²}(f). In this sense, we can say in this case that each matrix D(f) allows, for a temporal frequency band, the passage from an ambisonic representation to a plane wave representation.

Each matrix D(f) is hence formed of elements D_{k,i} that each represent the coefficient to be allocated to a value αᵢ(f) (obtained for an input signal βᵢ(t)) to determine its contribution to the plane wave emitted by the virtual sound source oriented along the direction Ωₖ(f). Indeed, the above matrix product means that we have:

Sₖ(f)=Σᵢ D_{k,i,αi}(f).

3In the example described herein, in which the storage unit 4 stores, for each temporal frequency band, data associated with a number of particular spatial directions Ωⱼ equal to the number of signals in the first set of signals (input signals), each matrix D(f) is a square matrix, of dimension equal to the number of signals in the first set, here (L+1)².

In the case where the input signals are ambisonic, a_{E}(Ωⱼ) is used to denote the vector whose coefficients express the transfer function between a plane wave propagating from the direction n; and the different ambisonic signals of order L:

a_{E}(Ωⱼ)=[Y₀⁰(Ωⱼ), Y₁⁻¹(Ωⱼ) . . . , Yₗ^{m}(Ωⱼ), . . . , Y_{L}^{L}(Ωⱼ)]^{T},

where Y^{m}(·) is the spherical harmonic function of order l and degree m.

For each temporal frequency band, the matrix D(f) can then be, in this case, defined by:

D(f)=pinv([a_{E}(Ω₁(f)), a _{E}(Ω₂(f)), . . . , a_{E}(Ω_{(L+1)}_{²}(f))]),

where pinv(·) represents the Moore-Penrose pseudo-inverse.

In the case where the matrix D(f) is square as indicated hereinabove, it can then be written:

D(f)=[a_{E}(Ω₁(f)), a_{E}(Ω₂(f)), a_{E}(Ω_{(L+1)}_{²}(f))]⁻¹.

As can be seen in FIG. 1, the decoding module 14 can comprise, in practice, a plurality of conversion units 16 each adapted to perform the above-mentioned conversion for a given temporal frequency band, i.e. here to perform the multiplication of a vector α(f) received from the transformation module 12 by the matrix D(f) associated with this frequency band.

The electronic device 2 comprises an encoding module 18 adapted to determine, for each temporal frequency band, a plurality of values π₁(f), π₂(f), . . . , λ_{N}(f) associated with the different signals of the second set (output signals), respectively, on the basis of the values δ₁(f), δ₂(f), . . . , δ_{(L+1)}_{²}(f) representative of the virtual sound sources and obtained by the above-mentioned conversion for the relevant temporal frequency band.

As indicated hereinabove, N is used to denote the number of signals of the second set.

For example, when the output signals are ambisonic signals of order L′, we have: N=(L′+1)².

In the example described herein, the number N of signals in the second set is strictly higher than the number of signals (here equal to (L+1)²) in the first set. This is in particular the case when the processing performed by the electronic device, described hereinafter with reference to FIG. 3, aims to artificially increase the spatial resolution of the sound scenes (function which is sometimes referred to as “upscaling”).

For example, when the input signals and the output signals are ambisonic signals, the order L′ of the output signals is strictly higher than the order L of the input signals.

In the example described herein, the encoding module 18 determines, for each temporal frequency band, the plurality of values λ₁(f), λ₂(f), λ_{N}(f) associated with the different signals of the second set, respectively, by matrix multiplication (by means of a matrix E(f)) of the vector δ(f) comprising the values δ₁(f), δ₂(f), . . . , δ_{(L+1)}_{²}(f) representative of the virtual sound sources and obtained at the conversion step for the relevant temporal frequency band.

Such a matrix E(f) has hence here a number of columns equal to the number of signals in the first set (here (L+1)²) and a number of lines equal to the number N of signals in the second set.

In the case where the output signals are ambisonic signals, the encoding module 18 uses, for each frequency band, a matrix E(f) allowing the passage from a plane wave representation to an ambisonic representation, here of order L′:

E(f)=[aₛ(Ω₁(f)), aₛ(Ω₂(f)), . . . , aₛ(Ω_{(L+1)}_{²}(f))]

with aₛ(Ωⱼ)=[Y₀⁰(Ωⱼ), Y₁⁻¹(Ωⱼ) . . . , Yₗ^{m}(Ωⱼ), . . . , T_{L}^{L′}(Ωⱼ)]^{T},

where, as already indicated, Yₗ^{m}(·) is the spherical harmonic function of order I and degree m.

By noting λ(f)=[λ₁(f), λ₂(f), λ_{N}(f)]^{T}, we then have: λ(f)=E(f)δ(f).

As can be seen in FIG. 1, the encoding module 18 can comprise, in practice, a plurality of processing units 20 each adapted to perform the just-described transformation for a given temporal frequency band, i.e. here to perform the multiplication of a vector δ(f) received from the decoding module 14 (precisely here: received from a conversion unit 16) by the matrix E(f) associated with this frequency band.

The electronic device 2 finally comprises a construction module 22 adapted to construct each signal σᵢ(t) of the second set on the basis of the values λᵢ(f) associated with this σᵢ(t) of the second set and obtained for the different temporal frequency bands, respectively.

The construction module 22 constructs for example each signal ai(t) of the second set by frequency-time transformation (such as an inverse short-term Fourier transformation) on the basis of the values λᵢ(f) associated with this signal of the second set and obtained for the different temporal frequency bands, respectively.

N output signals (signals of the second set) are hence obtained, precisely here, for each output signal, a set of values σᵢ(t) forming this output signal for the different (successive) times t of the considered time interval. The values of the different output signals for each time t can be noted in vectorial form: bₛ(t)=[σ₁(t), σ₂(t), σ_{N}(t)]^{T}.

FIG. 3 shows as a flow diagram a conversion method according to the invention. This method is for example implemented by the electronic device of FIG. 2, as described hereinafter.

The method of FIG. 3 starts by a step E2 of determining the format of the input signals b_{E}(t), here received by the reception module 6. This step E2 is for example implemented by the detection module 10. As an alternative, as already indicated, this step E2 could be implemented by the configuration module 8 reading metadata M indicative of the format of the input signals b_{E}(t).

This step E2 here makes it possible to determine the number of signals present in the first set of signals.

The method of FIG. 3 then comprises a step E4 of configuring the decoding module 14 and/or the encoding module 18 as a function of the format determined at step E2. This configuration step E4 is here implemented by the configuration module 8.

This step E2 can further comprise the configuration (here by the configuration module 8) of other elements of the electronic device 2, such as the transformation module 12 and/or the construction module 22. For example, the configuration module 8 configures the transformation module 12 and/or the construction module 22 as a function of the number of temporal frequency bands to be used (this number can be stored in a memory of the electronic device 2 and/or input by a user via a user interface—not shown—of the electronic device 2).

For example, during the configuration step E4, the configuration module 8 determines (as a function of the format determined at step E2) the matrices D(f) to be used, and configures the respective conversions units 16 by means of these matrices D(f).

The configuration module 8 determines for example the matrices D(f) to be used as a function of the number of signals present in the first set of signals.

According to a first possibility, as a function of the number of signals in the first set of signals (i.e. the number of input signals), the configuration module 8 reads a set of matrices D(f) stored (for example in the memory of the electronic device 2) in association with this number of signals in the first set of signals. As an alternative, the configuration module 8 could emit this number of signals in the first set of signals towards a remote server and receive as an answer the associated set of matrices D(f).

According to another possibility (for example implemented the first time the number of input signals determined at step E2 is met), the configuration module 8 carries out a method such as that described hereinafter in FIG. 4 to define a plurality of spatial direction 52ⱼ, allocate these spatial directions n; to the temporal frequency bands, and construct, for each temporal frequency band, the matrix D(f) using the spatial directions Ω₁(f), Ω₂(f), . . . , Ω_{(L+1)}_{²}(f) allocated to the relevant temporal frequency band (the construction of the matrix D(f) using the different spatial directions ni(f), Ω₂(f), . . . , Ω_{(L+1)}_{²}(f) having already been presented hereinabove). The so-constructed matrices D(f) can be stored (for example, in the memory of the electronic device 2) for later use (in accordance with the first possibility indicated hereinabove).

Likewise, during the configuration step E4, the configuration module 8 can determine the matrices E(f) to be used (for example as a function of the format of the output signals, here the number of output signals, that can be stored and/or input by a user via the user interface of the electronic device 2), and configure the processing units 20 by means of these matrices E(f).

The configuration module 8 determines for example the matrices E(f) to be used as a function of the number of signals present in the second set of signals (output signals).

According to a first possibility, as a function of the number of signals in the second set of signals (i.e. the number of input signals), the configuration module 8 reads a set of matrices E(f) stored (for example, in the memory of the electronic device 2) in association with this number of signals in the second set of signals. As an alternative, the configuration module 8 could emit this number of signals in the second set of signals towards a remote server and receive as an answer the associated set of matrices E(f).

According to another possibility (for example implemented the first time the chosen number of output signals is met), the configuration module 8 runs a method such as that described hereinafter with reference to FIG. 4 to define a plurality of spatial direction 52ⱼ, allocate these spatial directions Ωⱼ to the temporal frequency bands, and construct, for each temporal frequency band, the matrix E(f) using the spatial directions Ω₁(f), Ω₂(f), . . . , Ω_{(L+1)}_{²}(f) allocated to the relevant temporal frequency band (the construction of the matrix E(f) using the spatial directions Ω₁(f), Ω₂(f), . . . , Ω_{(L+1)}_{²}(f) having already been presented hereinabove). The so-constructed matrices E(f) can be stored (for example in the memory of the electronic device 2) for later use (in accordance with the first possibility indicated hereinabove).

The method of FIG. 3 then provides, for each of the signals β₁(t) of the first set (input signals), a step E6 of determining values αᵢ(f) associated with the different temporal frequency bands, respectively. In the example described, these different values αᵢ(f) associated with the different temporal frequency bands, respectively, represent the relevant signal αᵢ(t) in the frequency domain.

This determination step E6 is herein carried out by the transformation module 12. As already indicated, the values αᵢ(t) associated with said temporal frequency bands, respectively, can be determined by time-frequency transformation on the basis of the signals βᵢ(t) of the first set.

The method of FIG. 3 then comprises, for each temporal frequency band, a step E8 of converting the values αᵢ(f) associated with the relevant temporal frequency band and determined for the different signals β₁, β₂(t), . . . , β_{(L+1)}_{²}(t) of the first set, into values δ₁(f), δ₂(f), δ_{(L+1)}_{²}(f) representative of virtual sound sources oriented along the different spatial directions Ω₁(f), Ω₂(f), . . . , Ω_{(L+1)}_{²}(f), respectively, associated with (for example, allocated to) the relevant temporal frequency band.

This conversion step E8 is herein implemented by the decoding module 8, for example as already indicated, by performing the matrix products D(f)α(f) to obtain the different vectors δ(f)=[δ₁(f), δ₂(f), . . . , δ_{(L+1)}_{²}(f)]^{T}.

Precisely, for each temporal frequency band, one of the conversion units 16 performs a matrix product D(f)α(f) to obtain a vector δ(f) formed of the values δ₁(f), δ₂(f), δ_{(L+1)}_{²}(f) representative of virtual sound sources oriented along the different spatial directions Ω₁(f), Ω₂(f), . . . , Ω_{(L+1)}_{²}(f), respectively, for the relevant temporal frequency band.

The method of FIG. 3 then comprises a step E10 of determining, for each temporal frequency band, on the basis of the values δ₁(f), δ₂(f), δ_{(L+1)}_{²}(f) representative of the virtual sound sources and obtained at the conversion step E8 for the relevant temporal frequency band, a plurality of values λ₁(f), λ₂(f), λ_{N}(f) associated with the signals of the second set (i.e. the N output signals), respectively.

Step E10 is herein implemented by the encoding module 18, for example as already indicated, by performing the matrix products E(f)δ(f) to obtain the different vectors λ(f)=[λ₁(f), λ₂(f), λ_{N}(f)]^{T}.

Precisely, for each temporal frequency band, one of the processing units 20 performs a matrix product E(f)δ(f) to obtain a vector λ(f) formed o the values λ₁(f), λ₂(f), . . . , λ_{N}(f) associated with the signals σ₁(t), σ₂(t), . . . , σ_{N}(t) of the second set, respectively.

In the example described herein, the different values λᵢ(f) obtained for the different temporal frequency bands and associated with a same signal σᵢ(t) of the second set form a representation of this signal σᵢ(t) of the second set in the frequency domain.

The method of FIG. 3 then comprises a step E12 of construction of each signal σᵢ(t) of the second set on the basis of the values λᵢ(f) associated with this signal σᵢ(t) of the second set and obtained for the different temporal frequency bands, respectively.

Step E12 is herein implemented in the construction module 22.

As already indicated, each signal σᵢ(t) of the second set can be constructed by frequency-time transformation on the basis of the values λᵢ(f) associated with this signal σᵢ(t) of the second set and obtained for the different temporal frequency bands, respectively.

FIG. 4 presents a method for defining and allocating particular spatial directions Ωⱼ to different temporal frequency bands.

This method starts by a step E20 of defining a plurality of spatial directions by an optimization process, here so-called “Thomson problem” optimization process.

The plurality of so-obtained spatial directions forms a mesh (or grid) over the set of spatial directions, as already indicated.

This optimization process is described in the case of ambisonic input signals of order 1: in this case, as already indicated, 4 particular directions Ωⱼ are used for each temporal frequency band.

If F is used to denote the number of temporal frequency bands used (as already indicated, F is for example between 100 and 1000, here F=256), here F groups of 4 particular directions n; are provided (the number of particular directions per group is equal to the number of input signals, here 4 input signals for ambisonic signals of order L=1 as already indicated).

In each group, the particular directions are distributed in space and thus form, in the example described herein, a tetrahedron (for example a regular tetrahedron).

Rotations can be defined, which each allow passing from a tetrahedron defined for a group of particular directions to another tetrahedron, defined for another group of particular directions.

Each of the 4F particular directions n; is modelled as a charged particle located at the surface of a sphere, and moving integrally with the other directions belonging to the same group, i.e. to the same tetrahedron. Two charged particles exert on each other a repulsive force similar to the electrostatic interaction.

A cost function corresponding to the total potential energy of the so-modelled system is then defined.

By successive iterations, the above-mentioned rotations are changed so as to reach a minimum of potential energy (Thomson problem). Since the potential energy is all the greater as the particles are close to each other, this optimization leads to an optimum distribution of the directions on the sphere.

F tetrahedrons are hence obtained, arranged in such a way as to provide a regular sampling (and hence a mesh or grid) of all the possible spatial directions.

The method of FIG. 4 then comprises a step E22 of allocating the particular spatial directions obtained at step E20 to the F temporal frequency bands.

For that purpose, any one of the tetrahedrons (i.e. one of the particular direction groups) may be randomly allocated to the first temporal frequency band (the temporal frequency bands being for example ordered by increasing central frequency).

The tetrahedron allocated to the second temporal frequency band is that which corresponds to the smallest rotation with respect to the tetrahedron allocated to the first temporal frequency band. The other tetrahedrons are thus allocated successively to the different temporal frequency bands in such a way that the angular distance between two successive direction groups is as small as possible.

Two particular directions allocated to two adjacent frequency bands are hence neighbours in the mesh, which allows avoiding hops in the processing performed for two neighbour frequency bands.

A group of particular directions Ω₁(f), Ω₂(f), . . . , Ω_{(L+1)}_{²}(f) (corresponding to a particular tetrahedron in the example described herein) being allocated to each temporal frequency band, the method of FIG. 4 comprises a step E24 of constructing and storing, for each temporal frequency band, data associated with the particular spatial directions Ω₁(f), Ω₂(f), . . . , Ω_{(L+1)}_{²}(f) allocated to the relevant frequency band.

In the example described herein, for each temporal frequency band, the step E24 comprises constructing and storing the matrix D(f) and/or the matrix E(f) as indicated hereinabove, on the basis of the particular directions Ω₁(f), Ω₂(f), . . . , Ω_{(L+1)}_{²}(f) allocated to the relevant frequency band.

The just-described invention can be applied in different situations in which it is desired to convert a first set of signals having a first format into a second set of signals having a second format.

For example, when it is desired to reproduce ambisonic signals of relatively low order L (for example, of order L=1) by means of a significant number of loudspeakers (for example, by means of 10 loudspeakers or more), it is desirable to convert the ambisonic signals of order L into ambisonic signals of order L′, strictly higher than L, and to reproduce the converted signals on the loudspeakers in such a way as to avoid the production of artefacts unpleasant to the ear.

According to another example schematically shown in FIG. 5, it is sometimes desired to combine ambisonic signals be(t) of order L and ambisonic signals b′(t) of order L′ strictly higher than L. This is interesting in particular when the ambisonic signals b′(t) represent (in a detailed manner) a sound in direct propagation between a sound source and the user, whereas the ambisonic signals b_{E}(t) represent sounds arriving to the user after reflection and/or reverberation. The use of ambisonic signals b_{E}(t) of low order allows a reduction in the processing of these signals (for example, to produce these signals).

For example, in order to reproduce sounds represented that way, it is possible, in this case, to convert the ambisonic signals b_{E}(t) of order L into ambisonic signals bs(t) of order L′ thanks to the electronic device 2 and/or to the method of FIG. 3, then to combine the ambisonic signals bs(t) and the ambisonic signals b′(t) by means of a mixing device 5 (these two ambisonic signals being of the same order L′) in order to obtain a combined signal b″(t) (also ambisonic of order L′).

Moreover, although the above examples use ambisonic input and output signals, it is alternatively possible to use input or output signals of another type, for example multi-channel signals.

In this case, the different signals, each corresponding to a given loudspeaker position, is considered as a scene-based format in which the space-function base that is used consists of so-called “panning” functions. A panning function expresses the gains applied to the different loudspeakers to give the impression to a listener that a sound source is located in a given direction. The VBAP (“Vector Base Amplitude Panning”) method, for example, makes it possible to calculate panning functions for a given set of loudspeakers. For example, reference can be made to the article “Virtual Sound Source Positioning Using Vector Base Amplitude Panning”, of V. Pulkki, in Journal of the Audio Engineering Society, 45(6), pp. 456-466, June 1997.

The above-mentioned matrices D(f) and E(f) can in this case be constructed by concatenating the vectors consisted of the panning gains for the different plane wave directions

1. A method for converting a first set of signals (b_{E}(t)) representative of a sound field in a space into a second set of signals (bₛ(t)) by means of an electronic device (2), wherein the electronic device (2) is capable of storing, for each temporal frequency band of a plurality of temporal frequency bands of the sound field, at least one data item associated with a particular spatial direction (Ωⱼ), a set of these particular spatial directions (Ωⱼ) associated with a given said data item for at least one said temporal frequency band forming a mesh over the set of spatial directions, and wherein the method comprises:
for each signals (b_{E}(t)) of the first set of signals, determining (E6) a value (α(f)) associated with each of said temporal frequency bands;
for each one of the temporal frequency bands, converting (E8) the values (α(f)) associated with said one temporal frequency band and determined for a plurality of the signals of the first set of signals, into at least one value representative of a virtual sound source oriented along the spatial direction (Ωⱼ) associated with the data item stored for the said one temporal frequency band;
for each one of the temporal frequency bands, determining (E10), on the basis of said at least one value representative of a virtual sound source and obtained at the converting step (E8) for said one temporal frequency band, a value (λ(f)) associated with each of the signals (bₛ(t)) of the second set of signals;
constructing each one of the signals (bₛ(t)) of the second set of signals based on on the basis of the values (λ(f)) associated with said one signal of the second set of signals and obtained for each of the different temporal frequency bands.

2. The method according to claim 1, wherein the electronic device stores, for each said temporal frequency band, said data items associated with a number of said particular _spatial directions equal to a number of signals (b_{E}(t)) in the first set of signals.

3. The method according to claim 2, wherein, in the converting step (E8) performed for a given said temporal frequency band, the values (α(f)) associated with the given temporal frequency band and determined for the plurality of signals of the first set of signals are converted into a plurality of values (δ(f)) representative of the virtual sound sources oriented along the respective spatial directions (Ωⱼ) associated with the data items stored for the given temporal frequency band.

4. The method according to claim 2, wherein the particular directions associated with the data items stored for a given temporal frequency band are distributed among the set of spatial directions.

5. The method according to claim 1, wherein the number of signals in the second set is strictly higher than the number of signals in the first set.

6. The method according to claim 1, wherein two said directions associated with two said data items stored for two respective adjacent said frequency bands are neighbors in the mesh.

7. The method according to claim 1, wherein the set of said particular directions comprises at least 50 said particular directions.

8. The method according to claim 1, wherein the value (α(f)) associated with each of said temporal frequency bands is determined by time-frequency transformation based on signals (b_{E}(t)) of the first set.

9. The method according to claim 1, wherein each one of the signals (bₛ(t)) of the second set of signals is constructed by frequency-time transformation based on the values (λ(f)) associated with said one signal of the second set of signals and obtained for the plurality of temporal frequency bands.

10. The method according to claim 1, wherein, for each one of the temporal frequency bands, the converting step (E8) is carried out by matrix multiplication of a vector (α(f)) comprising the values associated with said one temporal frequency band and determined for the plurality of signals (b_{E}(t)) of the first set.

11. The method according to claim 1, wherein, for each one of said temporal frequency bands, the step (E10) of determining the values (λ,(f) associated with each of the signals (bₛ(t)) of the second set is carried out by matrix multiplication of a vector (δ(f)) comprising said at least one value representative of a virtual sound source and obtained at the converting step (E8) for said one temporal frequency band.

12. The method according to claim 1, further comprising preliminary steps of defining (E20) a plurality of said spatial directions by an optimization process, allocating (E22) said spatial directions of the plurality to said temporal frequency bands, and storing (E24), for each one of said temporal frequency bands, said at least one data item associated with the spatial direction allocated to said one temporal frequency band.

13. An electronic device (2) capable of converting a first set of signals (b_{E}(t)) representative of a sound field in a space into a second set of signals (bₛ(t)), said electronic device comprising:
a storage unit (4) adapted to store, for each said temporal frequency band of a plurality of said temporal frequency bands of the sound field, at least one data item associated with a particular spatial direction (Ωⱼ), so that a set of the particular spatial directions (Ωⱼ) associated with a said data item for at least one of the temporal frequency bands form a mesh over the set of spatial directions;
a transformation module (12) adapted to determine, for each of the signals (b_{E}(t)) of the first set of signals, a values (α(f)) associated with each of said temporal frequency bands, respectively;
a decoding module (14) adapted to convert, for each one of said temporal frequency bands, the values (α(f)) associated with said one temporal frequency band and determined for the different signals (b_{E}(t)) of the first set of signals, into at least one value representative of a virtual sound source oriented along the spatial direction associated with the data item stored for said one temporal frequency band;
an encoding module (18) adapted to determine, for each one of said temporal frequency bands, the values (λ(f) associated with each of the signals (bₛ(t)) of the second set of signals, absed on said at least one value representative of a virtual sound source and obtained by the decoding module for said one temporal frequency band;
a construction module (20) adapted to construct each one of the signals (bₛ(t)) of the second set of signals based on the values (λ(f) associated with said one signal of the second set of signals and obtained for each of the different temporal frequency bands.
